(19) United States
(12) Patent Application Publication
(10) Pub. No.: US 2008/0234024 A1
(43) Pub. Date: Sep. 25, 2008

(54) ELECTRONIC PLAYING CARD

(76) Inventors: Andrew P. Connors, Reston, VA (US); Marc A. Rossi, West Palm Beach, FL (US)

Correspondence Address: ROSSI, KIMMS & McDOWELL LLP., P.O. BOX 826, ASHBURN, VA, 20146-0826, US

(21) Appl. No.: 11/690,286

(22) Filed: Mar. 23, 2007

(51) Int. Cl. A63F 13/12

(52) U.S. Cl. 463/11; 463/31; 463/40

(57) ABSTRACT

The invention provides an electronic playing card comprising electronic paper that displays a playing card. Two or more of such electronic playing cards can comprise an electronic playing card deck. The invention further provides an electronic playing card shuffler for electronically shuffling an electronic playing card deck by way of a wired or wireless signal, or alternatively, by way of an electronic paper printer adapted to shuffle the electronic playing card deck. The invention additionally provides an apparatus for playing a card game with an electronic playing card deck in order to improve card game efficiency while maintaining a tactile experience.

### FIELD OF THE INVENTION

The present invention relates to playing cards and playing card games, and more particularly, to one or more electronic playing cards made out of electronic paper and an apparatus for shuffling and dealing the electronic playing cards.

### DESCRIPTION OF THE PRIOR ART

Casinos are always looking for ways to keep gaming fresh so that customers persistently view the gaming experience as exciting and different from other forms of entertainment. Additionally, casinos are always seeking ways in which games and procedures can be streamlined in order to encourage longer and more efficient play in order to increase the profitability of a casino gaming table.

Problems which can lead to inefficient game management and longer play are numerous. Some dealers shuffle or deal cards slower than others. The act of shuffling and dealing itself takes away from time that could otherwise be spent increasing the “drop,” or profitability, of a table by providing players with more betting opportunities. Additionally, dealers sometimes make mistakes in dealing by inadvertently showing cards which should not have been shown, leading to a misdeal or otherwise slower play. Further, such errors reduce the ability of players to effectively play a game, and decrease the players' confidence in the fairness of the game.

With the recent rise in popularity of Texas Hold'Em poker, casinos have an opportunity to provide players with the professional and exciting experience that is regularly broadcast on TV. Although casinos have offered several variants of poker for a long time, the recent surge in popularity of Texas Hold'Em has spurred poker room expansions in casinos and pushed those casinos to consider the experience they provide players and the efficiency of their poker room procedures. As part of their competitive outlook, casinos have recognized that they must provide an efficient and professional experience up to par with new and experienced player expectations. Yet despite these expectations, it is still common for dealer inefficiency and error to occur while playing poker at a casino.

In an attempt to solve these problems, PokerTek Inc. of Nevada has provided casino poker rooms with completely electronic poker tables. Betting occurs via the use of a standard display, and cards are also viewed on the display. Because poker requires players to hide their cards, the display is built in with a method for partially displaying cards upon appropriate interaction by a user. Community cards and the amount of money in the pot are displayed on a center screen. The system ultimately rectifies winners and losers according to established rules. A dealer and conventional shuffler are no longer necessary. This PokerTek technology is variously disclosed by US patent publications 2006/0058084 and 2005/0090304, among other publications.

While this system surely improves game efficiency and table drop, it does so at the cost of product differentiation for the casino and its poker room. Players utilizing the PokerTek system described above do not get the experience as seen on TV or that they otherwise ultimately expect. A large part of the thrill of visiting a casino is the tactile experience: feeling the chips and watching their satisfying splash, interacting with cards, and watching the game managed by a professional dealer. There is very little product differentiation between the PokerTek product and internet poker. This begs the question: why would a player go to a casino for an experience he could have in their own home? Hence, it is clear that their exists a need for a new technology which facilitates quick and efficient play of a card game, while maintaining the exciting and tactile experience uniquely offered at a casino.

Recently, new ways of displaying text and images have been developed using electronic paper or electronic ink technology, such as that owned by E-ink Corporation and the Massachusetts Institute of Technology and disclosed in numerous U.S. Patents, among them U.S. Pat. No. 5,930,026; 5,961,804; 6,017,584; 6,067,185; 6,118,426; 6,120,588; 6,120,839; 6,124,851; 6,130,773; 6,130,774; 6,172,798; 6,177,921; 6,232,950; 6,249,271; 6,252,564; 6,262,706; 6,262,833; 6,300,932; 6,312,304; 6,312,971; 6,323,989; 6,327,072; 6,376,828; 6,377,387; 6,392,785; 6,392,786; 6,413,790; 6,422,687; 6,445,374; 6,445,489; 6,459,418; 6,473,072; 6,480,182; 6,498,114; 6,504,524; 6,506,438; 6,512,354; 6,515,649; 6,518,949; 6,521,489; 6,531,997; 6,535,197; 6,538,801; 6,545,291; 6,580,545; 6,639,578; 6,652,075; 6,657,772; 6,664,944; 6,680,725; 6,683,333; 6,704,133; 6,710,540; 6,721,083; 6,724,519; 6,727,881; 6,738,050; 6,750,473; 6,753,999; 6,816,147; 6,819,471; 6,822,782; 6,825,068; 6,825,829; 6,825,970; 6,831,769; 6,839,158; 6,842,167; 6,842,279; 6,842,657; 6,864,875; 6,865,010; 6,866,760; 6,870,661; 6,900,851; 6,922,276; 6,950,200; 6,958,848; 6,967,640; 6,982,178; and 6,987,603, which are herein incorporated by reference.

Electronic paper is a flexible, image-stable, low power display that mimics standard paper but has the traits of a typical electronic display. Electronic paper can be equipped with wireless interfaces such as Bluetooth, Wi-Fi, and the like, or can be equipped with wired interfaces such as USB and the like. Through these interfaces in tandem with a display controller, the display of the electronic paper can be changed electrophoretically. As an additional advantage, electronic paper only needs to be powered when its display is changed. Various applications of electronic paper have been proposed, among them: as dynamic price tags in grocery stores, as enhanced advertising posters in store fronts, and as a component in compact portable devices such as Personal Digital Assistants and Cell Phones.

Electronic paper presents an interesting new medium which can solve the above-discussed problems. Additionally, electronic paper can be used to solve similar problems experienced with home poker games or for that matter, any card game played anywhere—casino or otherwise.

In light of the above, it would be desirable to provide an electronic playing card comprising electronic paper displaying a playing card. Further, it would be desirable to provide an electronic playing card deck comprised of a plurality of electronic playing cards, and a shuffler for distributing images of playing cards to each of the electronic playing cards comprising the electronic playing card deck.

### SUMMARY OF THE INVENTION

In a first embodiment, the invention provides an electronic playing card comprising electronic paper displaying a playing card. Preferably, the playing card is a standard playing card. It should be understood that electronic paper means a flexible, paper-like display consistent with or utilizing one or more of the following technologies: electronic ink, electronic paper, an electrophoretic display, an electro-optic display, Gyricon (registered trademark of Xerox Corporation), or the like. It should be further understood that a standard playing card means a card consisting of one of a rank of Ace, 2, 3, 4, 5, 6, 7, 8, 9, 10, Jack, Queen, and King and one of a suit of Hearts, Diamonds, Clubs, and Spades.

In a second embodiment, the invention provides an electronic playing card deck comprised of a plurality of electronic playing cards. Preferably, the electronic playing card deck comprises 52 electronic playing cards that each display an image of a unique standard playing card.

In a third embodiment, the invention provides an electronic playing card shuffler comprising a transmitting means for transmitting information to each electronic playing card of an electronic playing card deck, a computer-readable storage medium storing a plurality of images of playing cards, and a controller for distributing the images to the electronic playing cards via the transmitting means. The shuffler can further comprise a designating means for designating an identifier to be displayed on at least one of the electronic playing cards. An identifier may be useful in certain implementations of the invention so that a particular electronic playing card can be identified as belonging to a particular hand in a game or as belonging to a particular player of the game. Such an identifier may serve to deter or prevent cheating.

Preferably, the controller of the third embodiment distributes the images randomly or pseudo-randomly, analogous to the way that conventional playing cards are shuffled. Additionally, it is preferable that the controller distributes the images in a one-to-one manner, e.g. that there is exactly one image for every electronic playing card so that every electronic playing card is unique. It is envisioned, however, that there may be games in which one image is distributed to more than one of the electronic playing cards, such as games using a Joker. This distribution performed by the controller can occur over a wired or wireless system, or alternatively can occur by utilizing an electrophoretic device that causes the display of the electronic playing card to change, such as that found in an electronic paper printer. An exemplary electronic paper printer is disclosed in U.S. Pat. No. 7,114,864, which is herein incorporated by reference.

In a fourth embodiment, the invention provides an apparatus for playing a card game, comprising a playing surface and a deck of electronic playing cards. A playing surface can be a conventional casino card or poker table, among other playing surfaces. Preferably, the fourth embodiment further comprises an electronic playing card shuffler so that the card game can be run efficiently. It is envisioned, however, that a dealer can manually shuffle the electronic playing card deck in the same manner as a conventional playing card deck, rather than use the electronic playing card shuffler of the present invention. In this case, the images of playing cards are pre-distributed to each of the electronic playing cards of the electronic playing card deck, and do not change thereafter, so long as the electronic playing card shuffler is not utilized.

At least one electronic playing card of the electronic playing card deck can be wired to the playing surface in the fourth embodiment. In this configuration, it is preferable that the wire transmits a signal from the electronic playing card shuffler to the electronic playing card. By doing this, the playing surface can be persistently set according to a particular card game. For example, in the case of Texas Hold'Em, two hole electronic playing cards can be wired at each of a plurality of pre-designated player positions, and five electronic playing cards can be wired to form the “board”, e.g. the community cards of the game. As play progresses, the dealer can input commands to the electronic playing card shuffler to distribute images to the players' hole electronic playing cards as previously described, and further, to distribute images to the community electronic playing cards in the normal progression of the game according to the game rules. Of course, the electronic playing cards are all wired to the shuffler, and the wire supplies the necessary power to change the displays of the electronic playing cards. This power can originate from the shuffler, a power supply attached to the playing surface, or any number of other locations. This configuration has the advantages of maintaining a conventional feel to the electronic playing cards and reducing cost, since a wireless setup would necessitate that a battery exists on each individual electronic playing card.

As an additional configuration of the fourth embodiment, the electronic playing card shuffler can designate an identifier that is displayed on at least one electronic playing card of the electronic playing card deck. This identifier can comprise a character string which identifies the electronic playing card as belonging to a particular hand of the game. Further, the electronic playing card can display or otherwise include an identifier for identifying the player position that the electronic playing card belongs to. It should be understood that this identifier can be as simple as a sticker applied to the back of the electronic playing card. Obviously, a large number of implementations exist. It should be appreciated that both of the described identifiers provide ways to maintain game integrity and prevent or discourage cheating.

### BRIEF DESCRIPTION OF THE DRAWINGS

A fuller understanding of the present invention will become apparent upon consideration of the following detailed description taken in connection with the accompanying drawings, wherein:

FIG. 1A is a top-down view of an electronic playing card according to the first embodiment of the invention;

FIG. 1B is a close-up view of a portion of the electronic playing card of FIG. 1A;

FIG. 1C is a block diagram detailing the components of the electronic playing card of FIG. 1A;

FIG. 2A is a block diagram of an electronic playing card shuffler and an electronic playing card deck according to the second embodiment of the invention;

FIG. 2B is a flowchart illustrating a distribution method of the electronic playing card shuffler;

FIG. 3 is a top-down view of a playing surface, deck of electronic playing cards, and electronic playing card shuffler according to the fourth embodiment of the invention;

FIG. 4A is a top-down view of a playing surface, electronic playing card deck, and electronic playing card shuffler wherein the electronic playing cards of the electronic playing card deck are wired to the playing surface; and

FIG. 4B is a flowchart illustrating the method of operation of the electronic playing card shuffler in the configuration shown in FIG. 4A.

### DETAILED DESCRIPTION OF THE PREFERRED EMBODIMENTS

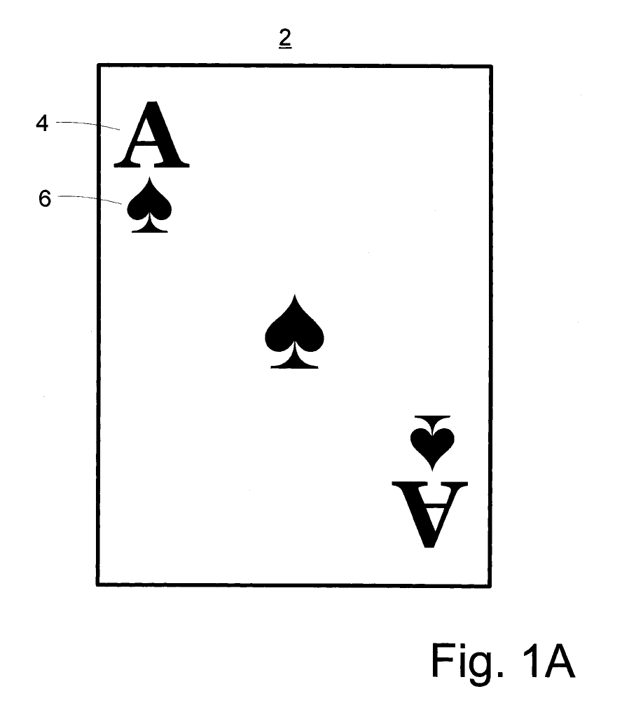

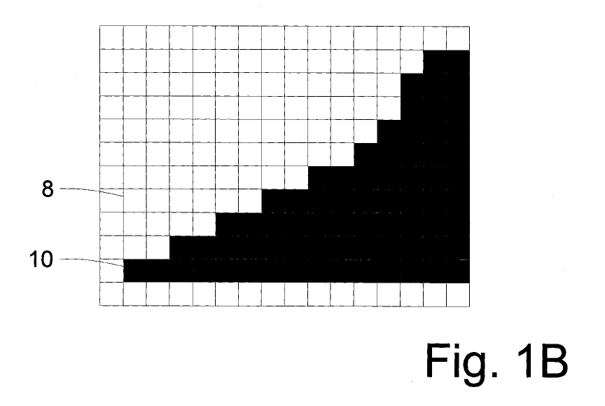

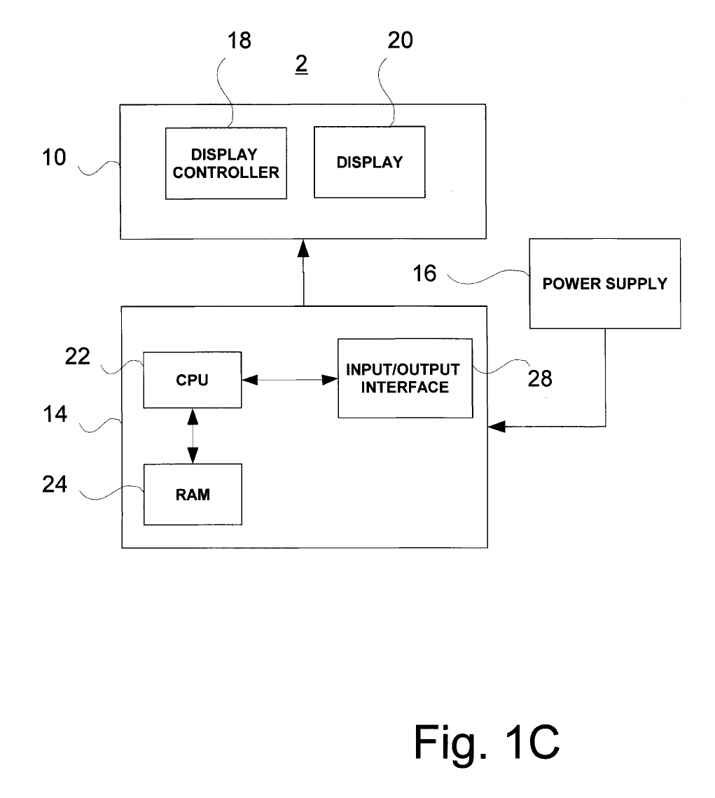

Referring to FIG. 1A, a first embodiment of the invention is illustrated. An electronic playing card 2, made from electronic paper, displays a rank 4 and a suit 6. Looking closer, FIG. 1B illustrates the actual composition of the electronic paper, which is made up of several cells, each containing a liquid or gaseous solution. A particular application of an electric field causes this solution to attract to the top or bottom of the cell that it is contained in, which respectively causes some cells 8 to appear white and other cells 10 to appear black. Further, it is well-known in the art that a polychromatic filter can be applied to the display so that image or text containing multiple colors can be displayed, hence enabling the electronic playing card 2 to take on the colors of a conventional playing card. It should be further understood that electronic paper might alternatively use bichromal beads, wherein one side is black and the other white, within cells 8 and 10. FIG. 1B, for illustrative purposes, shows a close-up view of the bottom left portion of the suit 6 of FIG. 1A. It should be understood that the cells may or may not be formed as squares, and can take on any number of shapes.

FIG. 1C shows a block diagram outlining the components of the electronic playing card 2. An electronic playing card 2 optionally comprises a power supply 16, such as a battery in the case where the power supply 16 is an integral part of the electronic playing card. Of course, the power supply 16 does not have to be an integral part of the electronic playing card, since power only needs to be supplied when the display of the electronic playing card needs to be changed, such as when the electronic playing card interacts with an electronic playing card shuffler. An electronic playing card 2 additionally comprises an electrophoretic display 12 that includes a display controller 18 and an actual display 20 comprising the previously described cells of FIG. 1B. It should be understood that the display controller 18 controls the application of an electric field to the display 20, and in some cases, it will not be necessary to include the display controller 18 in the electronic playing card 2, since an external device may be used to electrophoretically manipulate the display 20. Additionally, an on-board operating unit 14 comprises a Central Processing Unit (CPU) 22, Random Access Memory (RAM) 24, and an input/output interface 28 for sending and receiving information from an external source. The input/output interface 28 can comprise one or more of any number of conventional wired or wireless interfaces, including USB, Bluetooth, Wi-Fi, and the like.

A second embodiment of the invention comprises a plurality of electronic playing cards which constitute an electronic playing card deck. As should be readily understood, an electronic playing card deck preferably comprises 52 cards such that it has the same card makeup of a standard deck of playing cards. In light of the first embodiment and FIGS. 1A-1C, no further illustration is provided with respect to the second embodiment.

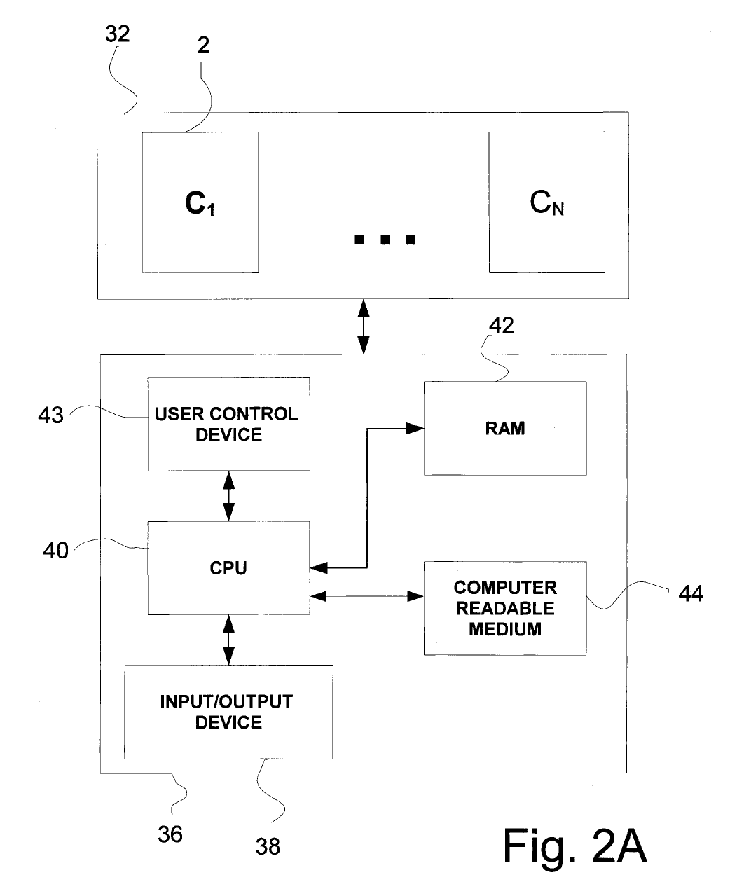

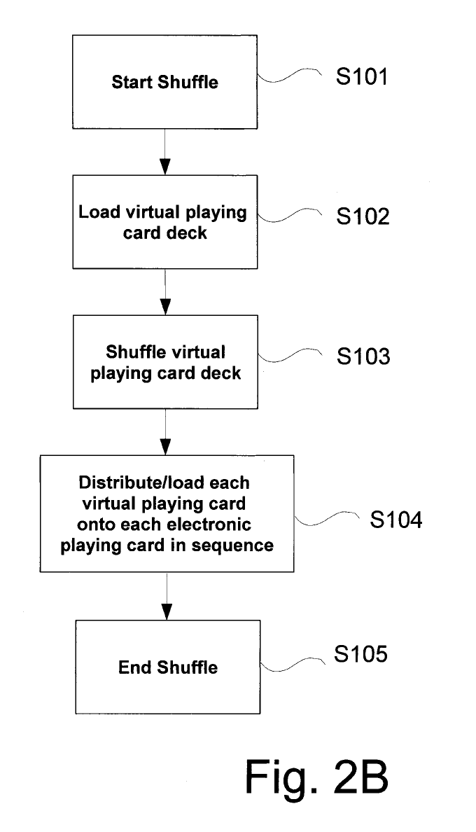

FIG. 2A illustrates a third embodiment of the invention, comprising an electronic playing card shuffler 36 that interacts with an electronic playing card deck 32. The electronic playing card deck 32 is comprised of N number of electronic playing cards C₁ to C_{N}, where N≧2, and preferably N=52. Initially, the electronic playing card deck 32 is blank or is otherwise unshuffled, e.g. images of playing cards have not been re-distributed to the electronic playing cards 2 of the electronic playing card deck 32 since the last hand of a card game. The electronic playing card shuffler 36 comprises an input/output device 38 for sending and receiving information to and from the electronic playing cards 2 of the electronic playing card deck 32. The input/output device 38 of the electronic playing card shuffler 36 can comprise one or more of any number of wired or wireless interfaces, including USB, Bluetooth, Wi-Fi, and the like, in accordance with the input/output device 28 of electronic playing cards 2 as shown in FIG. 1C. The electronic playing card shuffler 36 further comprises a CPU 40, RAM 42, user control device 43, and computer readable medium 44. The user control device 43 comprises a standard input device which a user can use to give shuffle and other game commands. Such an input device can comprise one or more of a keyboard, mouse, keypad, touch screen, display, or the like. The computer readable storage medium 44 can comprise a hard drive, floppy disk, USB drive, memory card, or the like. It should be readily understood that the electronic playing card shuffler 36 can be embodied in a purposely manufactured hardware device, or any number of conventional computing devices, including a laptop computer, PDA, or desktop computer.

FIG. 2B is a flowchart that illustrates the operation of the electronic playing card shuffler 36 of FIG. 2A. The shuffle starts at step S101 when the dealer or user of the electronic shuffler 36 enters the appropriate command into the user control device 43 as seen in FIG. 2A. This causes the electronic playing card shuffler 36 to load a virtual playing card deck into RAM 42 in step S102, which is stored in computer readable medium 44. A virtual playing card deck is a plurality of images representing playing cards. It should be understood that the term “image” can be of any known image data type, or for that matter, any data scheme which reduces to or implies a playing card. For example, an image of a playing card of the virtual playing card deck might simply be a data type storing a suit and rank of a card. In step S103, these cards are shuffled by a shuffle algorithm also stored on computer readable medium 44, the specifics of which are not important for the purposes of the invention.

It should be understood that there are many known algorithms for randomizing or pseudo-randomizing a set of data or otherwise “shuffling” the data. It should also be understood that “shuffling” simply means reordering the images constituting the virtual playing card deck. At a step S104, this reordering is used to distribute each image of a playing card, e.g. a virtual playing card, in sequence to the electronic playing cards 32 of FIG. 2A. Following step S105, the process proceeds to step S106 which marks the end of the shuffle. The electronic playing cards are now ready to be used in a card game. It should be noted that the virtual playing cards need not be reordered by the shuffle algorithm, but instead, their destinations can be reordered by the shuffle algorithm, e.g. it makes no difference if virtual playing cards are reordered in memory prior to their distribution to the electronic playing cards or the distribution itself follows the internal mechanism of the shuffle algorithm.

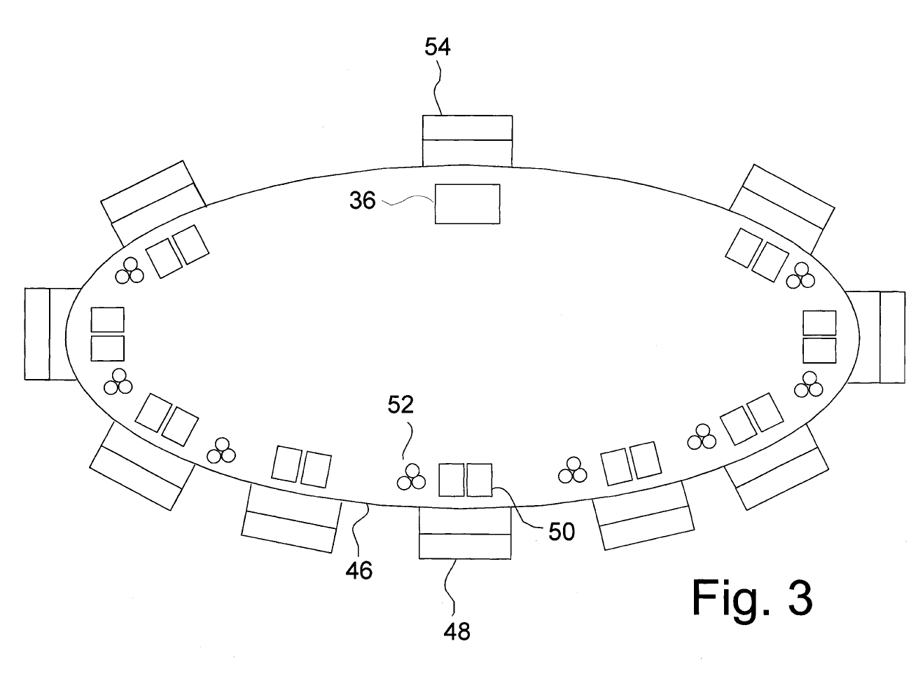

A fourth embodiment of the invention is shown in FIG. 3. For ease of illustration, the fourth embodiment will be discussed with deference to the game of Texas Hold'Em, although it should be readily understood that any card game is just as applicable to the present invention. An apparatus for playing a card game, as typically known, includes a playing surface 46 and conventional playing cards. Additionally, betting chips 52 are oftentimes used, although there use may not always be required. This may be because of the rules of the game, or because electronic betting input devices (not shown) can be used instead. In the present invention, conventional playing cards have been replaced by electronic playing cards, among them hole electronic playing cards 50 as shown in FIG. 3. These hole electronic playing cards 50 belong in pairs to each of their respective player positions 48. A dealer position 54 seats the dealer, who utilizes the electronic playing card shuffler 36, as previously described, and otherwise enforces the rules of the game. In this embodiment, the hole electronic playing cards 50 are physically dealt by the dealer to each player position 50 following a shuffle operation by the electronic playing card shuffler 36. In other words, the game proceeds conventionally, except for the use of the electronic playing card shuffler 36 to shuffle the cards.

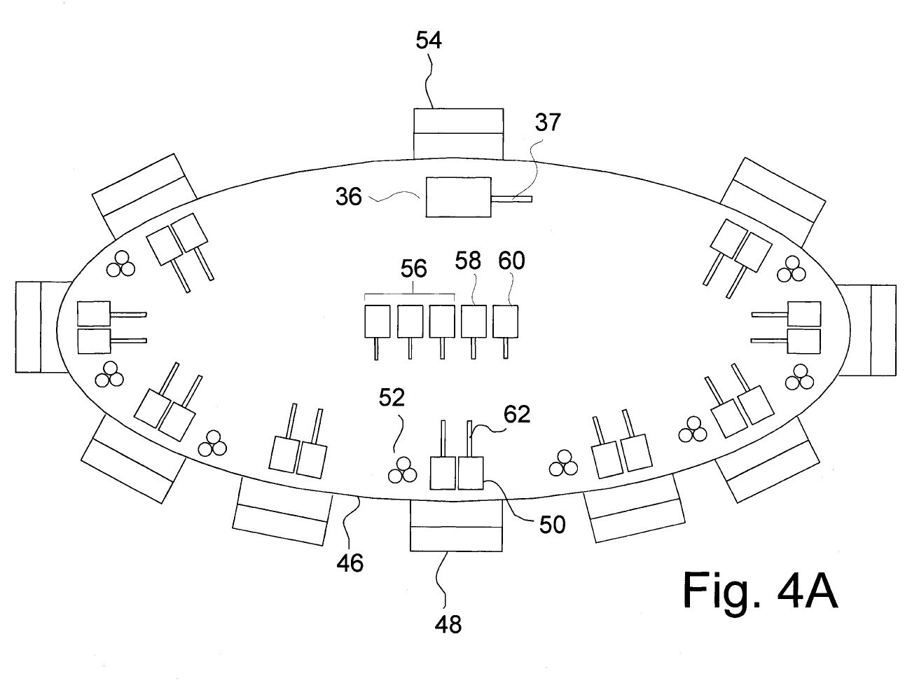

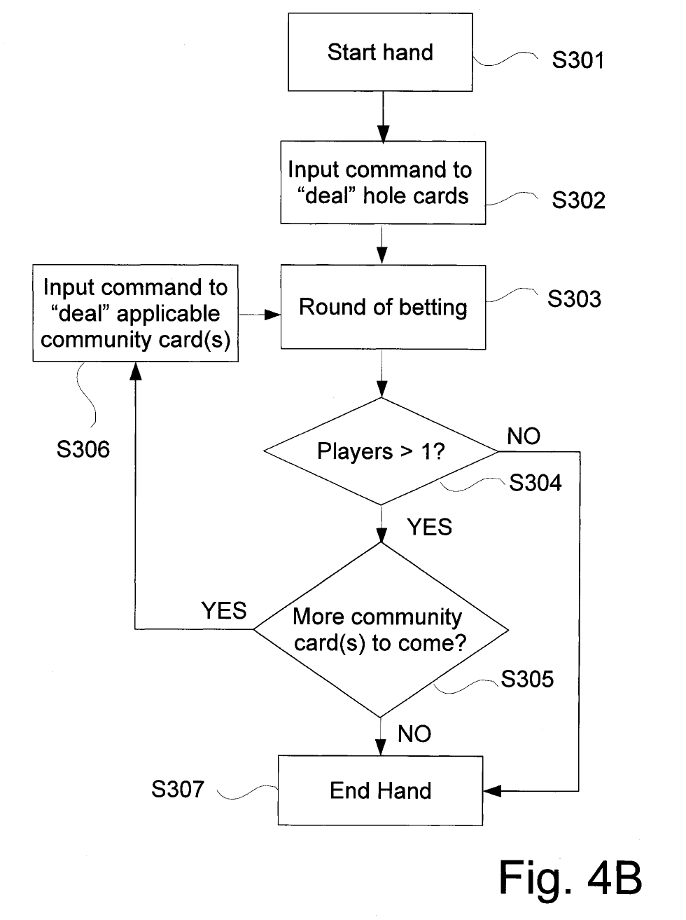

FIG. 4A shows an alternative configuration of the fourth embodiment of the invention. Here, a wire 62 runs from each hole electronic playing card 50 and community electronic playing cards 56, 58, and 60 to the electronic playing cards 36 by way of wire 37. These wires run through the playing surface 46 and meet in an appropriate manner underneath the playing surface 46. While this configuration is preferable so as to avoid an excess of wires on the playing surface, it should be understood that an infinite number of wire configurations exist. The wires 62 and 37 serve to transmit information and power from the electronic playing card shuffler 36 to the hole electronic playing cards 62 and the community electronic playing cards 56, 58, and 60. In the configuration of the fourth embodiment shown in FIG. 4A, the hole electronic playing cards 50 are disposed face down, while the community electronic playing cards 56, 58, and 60 remain face up.

The operation of a card game run on the apparatus shown in FIG. 4A will be further discussed with reference to FIG. 4B. FIG. 4B is a flowchart illustrating the process of running a hand of the card game on the apparatus. At step S301, a hand starts, and the playing surface is set as previously described and seen in FIG. 4A. At step S302, the dealer inputs a command into the electronic playing card shuffler 37 that causes a distribution to the hole electronic playing cards 62 to occur as described with respect to FIGS. 2A and 2B, with an important exception. Rather than distribute virtual playing cards to an entire electronic playing card deck, virtual playing cards are distributed only to the hole electronic playing cards 50. The community electronic playing cards 56, 58, and 60 remain face up and blank. At this stage, players sitting at player positions 48 may now view their particular hole electronic playing cards 62 at their discretion, by bending the cards upward, or in some other conventional way, just as with conventional playing cards. Play proceeds to step S303, where a round of betting occurs. At step S304, the dealer evaluates if there are two or more players remaining, and if there is the game proceeds to step S305. If only one player remains, the game ends at step S307 and that player wins the betting chips 52 bet during previous betting rounds. The card game is then reset to the start hand condition described at step S301. Going back to the case where more than one player remains, the dealer evaluates if there are community cards to be shown at step S305. In Texas Hold'em, community cards are shown in a particular order with particular groupings: first, a flop 56 is shown, consisting of 3 electronic playing cards; next, a single turn electronic playing card 58 is shown; and last, a single river electronic playing card 60 is shown. If more community cards need to be shown, then play proceeds to step S306, otherwise the game ends at S307, this time with the winning player decided by a showdown, whereby the player with a higher poker hand wins the betting chips 52 that have been bet during previous betting rounds. Assuming that play continues, at step S306 the dealer reveals the appropriate community cards to be shown by inputting a command to distribute a virtual playing card or cards to either the flop 56, turn 58, or river 60, as previously described with regards to FIGS. 2A and 2B. It should be noted that this operation is carried out in a similar manner as if one were using a conventional playing card deck, in that duplicates should not generally appear among the community electronic playing cards 56, 58, and 60 and the hole electronic playing cards 50. As previously described, there may be some circumstances where duplicates are used in the game, e.g. if Jokers are used.

As should be understood from the above description, the invention provides many advantages over the standard apparatus and method for playing a card game. Because cards are not thrown across the table in the course of dealing, there is no risk of the dealer accidentally exposing a card that should not be exposed. Further, because cards are shuffled and dealt at the push of a button, cards are shuffled and dealt more expediently than in a conventional manner. If the previously described identifiers are used, game integrity can be maintained in a better manner than in conventional card games, and additionally, the dealing method described prevents a dealer from setting the playing card deck in order to cheat through collusion with another player. Last, the invention provides an improved experience over tables like the one offered by PokerTek, Inc., since the invention maintains the tactile experience.

The invention has been described with reference to certain preferred embodiments thereof. It will be understood, however, that modifications and variations are possible within the scope of the appended claims.

What is claimed is:

1. An electronic playing card, comprising:
electronic paper displaying an image of a playing card.

2. The electronic playing card according to claim 1, wherein the image is of a standard playing card.

3. An electronic playing card deck, comprising:
a plurality of electronic playing cards.

4. The electronic playing card deck according to claim 3, wherein the electronic playing card deck comprises 52 electronic playing cards that each display an image of a unique standard playing card.

5. An electronic playing card shuffler, comprising:
a transmitting means for transmitting information to each electronic playing card of an electronic playing card deck;
a computer-readable storage medium storing a plurality of images of playing cards;
a controller for distributing the images to the electronic playing cards via the transmitting means; and
a user control device for inputting commands.

6. An electronic playing card shuffler according to claim 5, further comprising:
a designating means for designating an identifier to be displayed on at least one of the electronic playing cards.

7. The electronic playing card shuffler according to claim 5, wherein the controller distributes the images randomly or pseudo-randomly.

8. The electronic playing card shuffler according to claim 5, wherein the controller distributes the images to the electronic playing cards in a one-to-one manner.

9. The electronic playing card shuffler according to claim 5, wherein the controller comprises a computer-readable storage medium storing a computer program that performs the distribution.

10. The electronic playing card shuffler according to claim 5, wherein the transmitting means comprises a wire that transmits a signal.

11. The electronic playing card shuffler according to claim 5, wherein the transmitting means comprises a device that transmits a wireless signal.

12. The electronic playing card shuffler according to claim 5, wherein the transmitting means comprises a device utilizing electrophoresis to cause the display of the electronic playing card to change.

13. An apparatus for playing a card game, comprising:
a playing surface and
a deck of electronic playing cards.

14. An apparatus for playing a card game according to claim 13, further comprising:
an electronic playing card shuffler.

15. An apparatus for playing a card game according to claim 14, wherein at least one electronic playing card of the electronic playing card deck is wired through the playing surface and to the electronic playing card shuffler.

16. An apparatus for playing a card game according to claim 15, wherein the wire is used to transmit a signal from the electronic playing card shuffler to the electronic playing card.

17. An apparatus for playing a card game according to claim 14, wherein at least one electronic playing card of the electronic playing card deck displays an identifier identifying a hand which the electronic playing card belongs to.

18. An apparatus for playing a card game according to claim 14, wherein at least one electronic playing card of the electronic playing card deck includes an identifier identifying a player position which the electronic playing card belongs to.
